(19) United States
(12) Patent Application Publication
(10) Pub. No.: US 2026/0168928 A1
(43) Pub. Date: Jun. 18, 2026

(54) Asymmetric Probe, Planar Transient Grating Spectroscopy System

(71) Applicant: Massachusetts Institute of Technology, Cambridge, MA (US)

(72) Inventors: Jonas Rajagopal, Arlington, MA (US); Angus Wylie, Somerville, MA (US); Benjamin Reid Dacus, Boston, MA (US); Michael Philip Short, Cambridge, MA (US)

(21) Appl. No.: 18/983,266

(22) Filed: Dec. 16, 2024

(51) Int. Cl. G01N 21/63; G01N 21/17

(52) U.S. Cl. CPC G01N 21/636; G01N 21/1717

(57) ABSTRACT

A transient grating spectroscopy system for characterizing a sample may include a phase mask, optical element, and a detector. The phase mask may be configured to separate pulsed pump electromagnetic radiation propagating along a pump incident path. The phase mask may also be configured to separate probe electromagnetic radiation propagating along a probe incident path, into a reference component and a probe component. The optical elements may be arranged to direct the pump components, the reference component, and the probe component to an inspection location at the sample, the pump components forming a sample transient grating at the inspection location. The reference component and a portion of the probe component may form a homodyned signal in a detection path as a function of interaction with the sample transient grating. The reference component, the probe component, and a portion of the homodyned signal may be substantially in the common plane.

### BACKGROUND

Transient grating spectroscopy (TGS) is a rapid and non-destructive technique for measuring thermal, acoustic, and elastic properties of solid materials with a multitude of uses across many areas of materials research. Conventional TGS systems are complex and require cumbersome amounts of space.

### SUMMARY

Example embodiments herein may involve an asymmetric probe and planar (APP) geometry. Example embodiments herein may involve an asymmetric probe without a planar geometry.

A transient grating spectroscopy system for characterizing a sample may include a means for separating pulsed pump electromagnetic radiation propagating along a pump incident path into pump components. In some example embodiments, the transient grating spectroscopy system may include a means for separating probe electromagnetic radiation propagating along a probe incident path, angularly offset from the pump incident path, into a reference component and a probe component the reference component, and the probe component being substantially in a common plane. In some example embodiments, the optical elements may be arranged to direct the pump components to an inspection location on an inspection surface at the sample and to direct the reference component and the probe component to the inspection location, the pump components forming a sample transient grating at the inspection location. The reference component and at least a portion of the probe component may form a homodyned signal in a detection path as a function of interaction with the sample transient grating. At least a portion of the homodyned signal may be substantially in the common plane. In some example embodiments, the transient grating spectroscopy system may include optical elements. The optical elements may be arranged to direct the reference component and the probe component to the inspection location from a forward path side of a plane that intersects the inspection surface. In some example embodiments, the detection path may be at a reverse path side of the plane that intersects with the inspection surface. In some example embodiments, the transient grating spectroscopy system may include a detector. The detector may be arranged to detect the homodyned signal for use in collecting data for characterizing the sample.

In some example embodiments, the means for separating the pulsed pump electromagnetic radiation and separating the probe electromagnetic radiation may include a phase mask.

In some example embodiments, the system may further include a pump source configured to emit the pulsed pump electromagnetic radiation along the pump incident path and a probe source configured to the emit probe electromagnetic radiation along the probe incident path.

In some example embodiments, the system further may include a fixture, optical elements, or combination thereof, constructed and arranged to secure the pump source and the probe source such that the pump incident path and the probe incident path are at an angular offset.

In some example embodiments, the wavelength of the probe electromagnetic radiation may be different than the wavelength of the pump electromagnetic radiation.

In some example embodiments, the reference component may propagate from the phase mask to the inspection location along a reference component path and the probe component may propagate from the phase mask to the inspection location along a probe component path, the length difference between the reference component path and the probe component path being less than the coherence length of the probe source.

In some example embodiments, the pump incident path may be configured to be orthogonally incident at a position of the phase mask and the probe incident path is configured to be non-orthogonally incident at the position of the phase mask.

In some example embodiments, the optical elements may include a pump beam stop configured to block the zeroth order pump component, and a probe beam stop configured to block the zeroth order component of the probe electromagnetic radiation.

In some example embodiments, the reference component may be a (+1) order probe component of the probe electromagnetic radiation and the probe component may be a (−1) order probe component of the probe electromagnetic radiation.

In some example embodiments, wherein the homodyned signal may include the reflection of the reference component and the diffraction of the probe component off the sample transient grating.

In some embodiments, the detector is communicatively coupled with a signal processor that may be configured to interpret a representation of the homodyned signal produced by the detector to be the characteristic of the sample.

In some example embodiments, the phase mask, optical elements, and detector may be elements in a handheld device.

In some example embodiments, the pump components may include a positive order pump component and a corresponding equivalent negative order pump component. The phase mask and optical components may be configured to direct the positive order pump component and the corresponding negative order pump component to the inspection location such that the two pump components are symmetric about a plane that intersects with the inspection surface. The reference component may be incident at the inspection location from a first side of the plane. The pump component may be incident at the inspection location from the first side of the plane. The detection path may be at a second side of the plane.

A method of using transient grating spectroscopy may comprise separating a pulsed pump electromagnetic radiation along a pump incident path into pump components. The method of using transient grating spectroscopy may comprise separating probe electromagnetic radiation traveling along a probe incident path, angularly offset from the pump incident path, into a reference component and a probe component. The reference component and the probe component may be substantially in a common plane. The method of using transient grating spectroscopy may comprise directing the pump components to an inspection location on an inspection surface at a sample. The method of using transient grating spectroscopy may comprise directing the reference component and the probe component to an inspection location at the sample from a forward path side of a plane that intersects the inspection surface, the pump components forming a sample transient grating at the inspection location and the reference component and at least a portion of the probe component forming a homodyned signal in a detection path as a function of interaction with the sample transient grating. The detection path may be at a reverse path side of the plane that intersects with the inspection surface. At least a portion of the homodyned signal may be substantially in the common plane. The method of using transient grating spectroscopy may comprise detecting the homodyned signal for use in collecting data for characterizing the sample.

A method of using transient grating spectroscopy may comprise illuminating an inspection location on an inspection surface with pump electromagnetic radiation along a first pump incident path and a second pump incident path to form a sample transient grating at the inspection location, the first pump incident path and the second pump incident path being symmetric about a plane that intersects with the inspection location. The method of using transient grating spectroscopy may comprise illuminating the inspection location with reference electromagnetic radiation along a reference incident path and with probe electromagnetic radiation along a probe incident path, the reference incident path and the probe incident path being incident from a forward path side of the plane that intersects with the inspection surface. In some example embodiments, the plane may intersect with the inspection surface at an orthogonal angle. The method of using transient grating spectroscopy may comprise detecting collected electromagnetic radiation that propagates along a collection path, the collected electromagnetic radiation resulting from interactions of the reference electromagnetic radiation, the probe electromagnetic radiation, and the sample transient grating, the collection path being at a reverse path side of the plane that intersects with the inspection surface.

In some example embodiments, the first pump incident path, the second pump incident path, the reference incident path, the probe incident path, and the collection path are in a common plane.

In some example embodiments, the common plane is substantially horizontal relative to a surface to which optical components used to perform the method are mounted.

In some example embodiments, the method further comprises separating pump electromagnetic radiation into the first pump incident path and the second pump incident path using a phase mask.

In some example embodiments, the first pump incident path and the second pump incident path are non-zeroth order components of the pump electromagnetic radiation.

In some example embodiments, the method further comprises separating probe electromagnetic radiation into the reference electromagnetic radiation along the reference incident path and the probe electromagnetic radiation along the probe incident path using a phase mask.

In some example embodiments, the reference electromagnetic radiation and the probe electromagnetic radiation are non-zeroth order components of the probe electromagnetic radiation.

In some example embodiments, the homodyned signal comprises the reflection of the reference component of the probe electromagnetic radiation and the diffraction of the probe component of the probe electromagnetic radiation off the sample transient grating.

In some example embodiments, the plane intersects with the inspection surface at an orthogonal angle.

A method of using transient grating spectroscopy may comprise producing a sample transient grating at an inspection location of a sample using pulsed pump electromagnetic radiation. The method of using transient grating spectroscopy may comprise directing a reference component and probe component of probe electromagnetic radiation at an angle to the sample transient grating to produce a reflected reference component and a diffracted probe component to form a homodyned signal. The method of using transient grating spectroscopy may comprise detecting the homodyned signal to produce a representation of characteristics of the inspection location of the sample. In some example embodiments, the pulsed pump electromagnetic radiation, the reference component, and the probe component are in a common plane.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows a perspective illustration of an example grating formation. A<500 ps pump pulse induces the grating (top) and a continuous wave probe monitors the decay of the grating (bottom)¹³. This figure was published in Journal of Nuclear Materials, 586, Wylie et al., Thermal diffusivity, microstructure and nanohardness of laser-welded proton-irradiated Eurofer97, 1546621, Copyright Elsevier (2023).

FIG. 2 shows an optical diagram of an example embodiment of a Mini-TGS. The beam cross-section shows how, in this example embodiment, all beams lie in the same plane. For this example embodiment, each beamline has two alignment mirrors, two alignment irises, and a focusing lens. Diffraction angles are exaggerated for clarity.

FIG. 3 shows an example optical diagram of a box-car di-homodyne TGS system. The beam cross-sections highlight differences compared to FIG. 2. Diffraction angles are exaggerated for clarity.

FIG. 4 shows a photograph of an example embodiment of a Mini-TGS system, showing the noticeable reduction in component number and complexity compared to a common TGS (see FIG. 5). The pump and probe laser may also be cage-mounted with smaller alignment mirrors for additional compactness. Finally, the entire system could be easily contained in a compact CNC-machined housing, made much easier by the asymmetric probe and planar (APP) geometry.

FIG. 5 shows an example of a conventional TGS system, showing a far more complex system with more and larger components than the Mini-TGS in FIG. 4.

FIG. 6A shows an example TGS signal produced by an example embodiment of a Mini-TGS with a 99.99% pure tungsten sample with a {001} surface orientation. The noise baseline has been subtracted away and the oscillations around 50-75 ns represent volumetric transient grating signals originating from the air in front of the sample, and can therefore be ignored.

FIG. 6B shows the fast Fourier transform (FFT) on the signal from FIG. 6A and Lorentzian fit of the FFT.

FIG. 7 shows example on-sample power and on-sample size, measured as the full-width at half maximum (FWHM) of the Gaussian fit of the beam profile, for the pump and probe for each setup. The benchmark system was a di-homodyne system and therefore has two spot sizes for the probe.

### DETAILED DESCRIPTION

A description of example embodiments follows.

Transient grating spectroscopy is a rapid and non-destructive technique for directly measuring thermal, acoustic, and elastic properties of solid materials, and inferring many others, with a multitude of uses across many areas of materials research. Current TGS systems require optics tables and cumbersome amounts of space for an entire setup restricting TGS to being a lab-based method. Systems and methods described herein may involve a new design for TGS systems that rotates the probe laser beams around the axis of the pump beam allowing for an asymmetric probe, planar setup. This, in turn, allows the setup to be significantly simplified which enables the setup to be roughly 9 times smaller in volume than conventional setups while being much easier to build, align, and operate. Example designs herein enable TGS to be more widely adopted and used in compact environments. This device was benchmarked against existing TGS systems using a single-crystal tungsten sample. This showed that it can produce the same surface acoustic wave (SAW) frequency data as the existing system.

Transient grating spectroscopy (TGS) is a rapid, nondestructive optical technique for measuring thermal, acoustic, and elastic properties of the top several microns of a material. It was pioneered over two decades ago¹, and is particularly useful for measuring semiconductor properties³⁻⁵, thin films⁶, and in situ changes to material surfaces⁷. It has also contributed to numerous basic scientific discoveries, from phonon transport in microsphere lattices⁸ to thermal transport in liquids⁹ to inferring the presence of radiation defects and their clustering¹⁰.

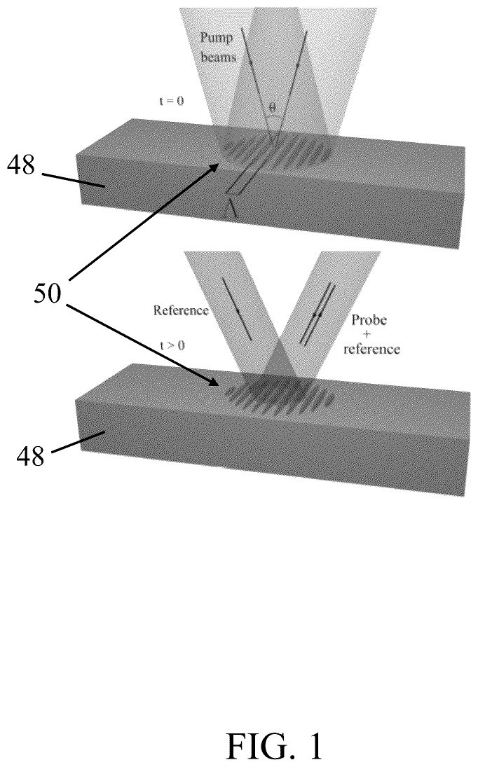

TGS uses a pulsed, pump laser to heat a grating pattern with spacing A on a sample by crossing two beams at an angle θ, causing the illuminated stripes on-sample to rise in temperature, as shown in FIG. 1. When the pump fires, these stripes are heated on the sample and the heat then decays away while the pump is not firing. A probe laser subsequently diffracts off the transient grating formed on the sample by the excitation created by the pump lasers. FIG. 1 shows this process. The strength of this diffracted probe signal conveys the time evolution of the transient grating on the sample. Measuring this diffracted probe signal and how its intensity decays after a pump pulse gives information about the thermal, elastic, and acoustic properties of a sample.

One of TGS's strengths lies in its multifaceted signal, whereby combinations, of elastic, thermal, and acoustic property changes measurable by TGS can be used to infer the kinetics, extent, and/or onset of changes of ultimate interest with some knowledge about the material or material family/system. Another is the rapid, non-contact nature of TGS. A common use of TGS involves measuring the SAW frequency, which can either be of used to infer changes sensitive to porosity or elastic constants^{7,9,11,12}. SAWs originate from the pump excitation and their speed (and therefore frequency) along with their relatively slow attenuation compared to bulk waves means that they can be informative about the elastic properties of a material¹². This, in turn, can be used to infer changes in any material property which directly couples to bulk elasticity, such as porosity.

For example, TGS can be used to measure how certain properties of a material change when it is irradiated, for example by detecting the onset of void swelling via porosity induced stiffness reduction.^{7,14,15} It can also be used to measure how materials that have already been irradiated have degraded, by measuring changes to thermo-elastic properties in tandem with known correlations between a given material's properties and aforementioned degradation. Using TGS to measure the properties of a material takes seconds to minutes, so it can also be used with additional ion or neutron beams, in some embodiments simultaneously, to rapidly test how candidate materials for a nuclear fusion power plant perform in specific conditions that are meant to mimic those the material would sustain in operation¹⁶.

However, current, state-of-the-art, TGS systems require an optics table and unwieldy amounts of space for the entire system including the lasers, alignment optics, the sample, and the detection optics. The complexity of the setup mandates a trained expert to assemble and maintain it and means it is typically used in laboratory environments. This is likely one reason that it has not been more widely adopted across the scientific and engineering communities, despite its potential applicability to non-destructively measure material properties and reveal new scientific discoveries. Example embodiments described herein change that. Systems and methods described herein may involve a planar and miniature TGS system that provides many of the same functions but drastically reduces the size and complexity. This design expands upon the state-of-the-art systems by incorporating several innovations regarding the placement of optics, dual-use components, and theory-guided simplifications to the system to enable the TGS to fit inside very compact environments. Some example embodiments may fit inside internal beam-target cyclotron accelerators. Some example embodiments described herein also enable the usage of TGS as a process-control system, which had been proposed since the early 2000s¹⁷.

Some example embodiments presented herein utilize an asymmetric probe and planar (APP) geometry leading to the compactness and robustness described herein. The nature of the design cuts out many optics while maintaining the functionality, enabling this design to be roughly 9 times smaller in volume than common box-car systems, in essence a “Mini-TGS”.

In the manufacturing sector, a miniature and/or portable TGS system could be used to monitor the application of surface films on samples and to measure the material properties of manufactured materials. Existing TGS setups not only require significant lab space, which is often at a premium and is not available for many applications, but they also have a high barrier to entry. Example embodiments described herein lower the barrier to entry to TGS and increasing the number of labs around the world utilizing TGS will expedite crucial materials research in many fields. For example, finding suitable materials is one of the major challenges to be overcome before achieving commercially viable fusion power plants; TGS can rapidly screen candidate materials for retained thermo-mechanical properties as a measure of damage resistance, thereby accelerating this research¹². It may take new groups months to build, calibrate, and understand existing TGS system with all their complexities, making it unsuitable for widespread deployment and utilization for rapid, automated materials investigation.

Using example embodiments described herein, a TGS system can be shipped ready to go, with initial calibration taking tens of minutes to an hour. Then, when paired with an ion accelerator, a hot/cold stage, or other equipment, the simplified TGS setup becomes a much more versatile, in situ tool for materials kinetics investigations. These include optimizing Ni-based super-alloy heat treatments for aerospace applications, optimizing film growth of anti-corrosion and antifouling coatings, quickly designing new heat treatments for steels, or sorting materials by their resistance to radiation damage¹². For example, heating a specimen during irradiation with in situ TGS allows one to pinpoint the onset of void swelling, a life-limiting degradation phenomenon for many nuclear structural materials^{7,15}. The existing, design makes this difficult to accomplish, while with the proposed APP geometry a TGS can far more easily fit in the confines of a particle accelerator or an even more compact application.

Another application of a miniature, easy-to-use TGS system is nuclear reactor pressure vessel (RPV) testing. A handheld system could be designed around the core optics and example embodiments presented herein allow inspectors to test the integrity of RPVs by non-destructively probing their thermal and acoustic properties, which may be strongly correlated to fracture properties of ultimate interest. This could help extend the lifespan of current nuclear power plants since a nondestructive testing method is required to determine if an RPV is safe for operation once all in-vessel surveillance coupons have been exhausted. This system could also theoretically be used in water to test an airtight system, allowing for inspection of the inner liner of an RPV without drainage.

### Example Designs

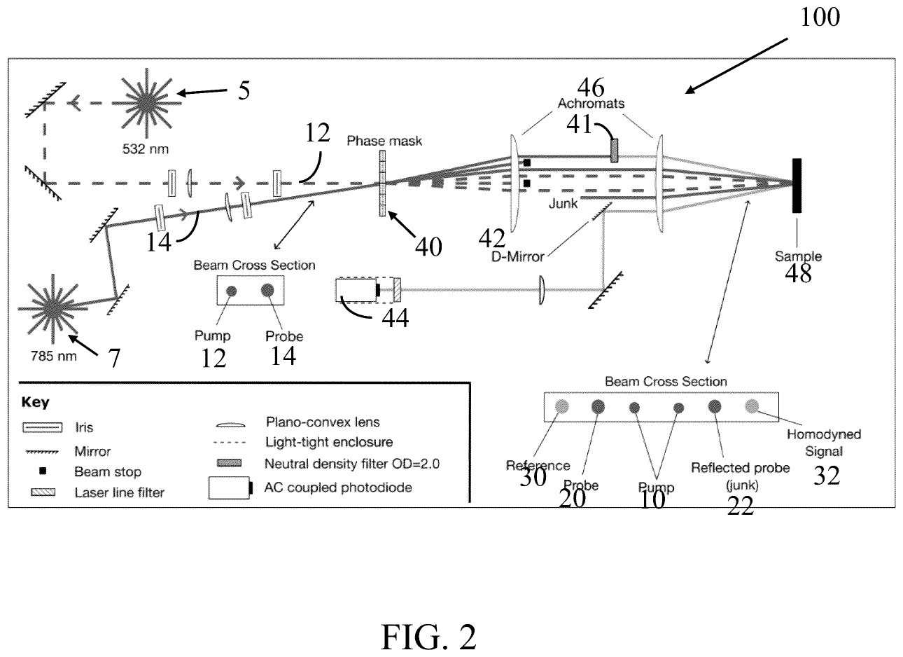

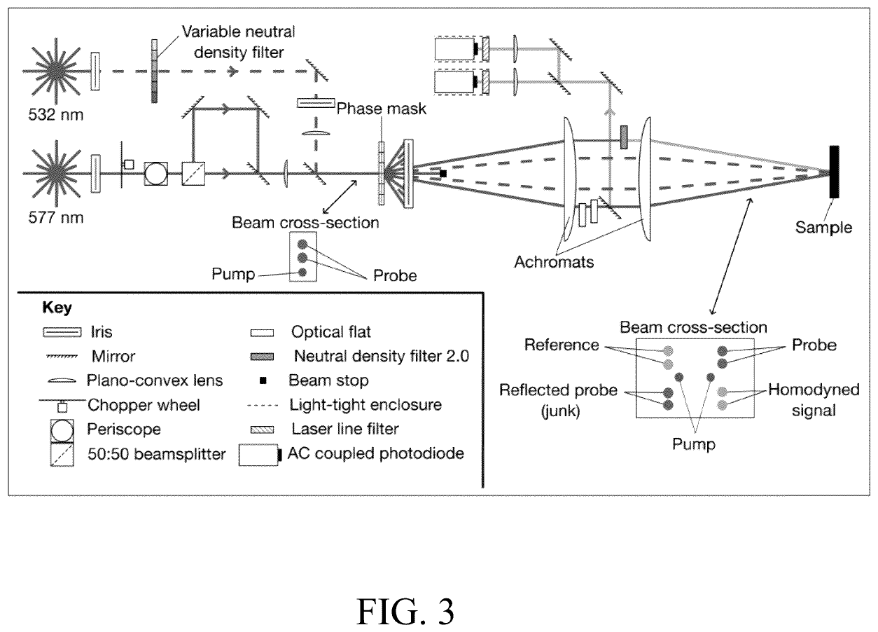

In some example embodiments, the entire setup has a symmetric probe and is entirely planar, greatly reducing the number of optical degrees of freedom, and reducing the size of the system. A conventional TGS system is 3D: The probe lasers hit the sample from above the pump and reflect off the sample below the pump so the signal beams can be picked off without blocking the incoming beams, though exceptions exist^{11,18}. This can be seen in the beam profile for a common box-car TGS system in FIG. 3. The 3D nature of the setup makes alignment more difficult because the probe beams are not flat so cage systems cannot be as effective. When a setup is flat, the cage systems can be anchored on fixed posts ensuring their height is correct. Example Mini-TGS setups may rotate the probe 90 degrees around the pump axis. The probe and pump are therefore always in the same plane. A full schematic of an example Mini-TGS 100 can be seen in FIG. 2. Between the imaging lenses, the probe 20 is offset horizontally as opposed to being offset both horizontally and vertically. The planar nature of the setup means that simple horizontally flat cage rods with caged irises on them can be used for the alignment. This makes aligning the setup significantly easier—the cages mean the irises are exactly where they need to be. The planarity of the setup also makes the setup safer as there are fewer chances for beams to suffer stray reflections as all beams stay in-plane. The beam cross-section in FIG. 2 shows how all the beams are planar. In some example embodiments, the Mini-TGS system does not use a cage system.

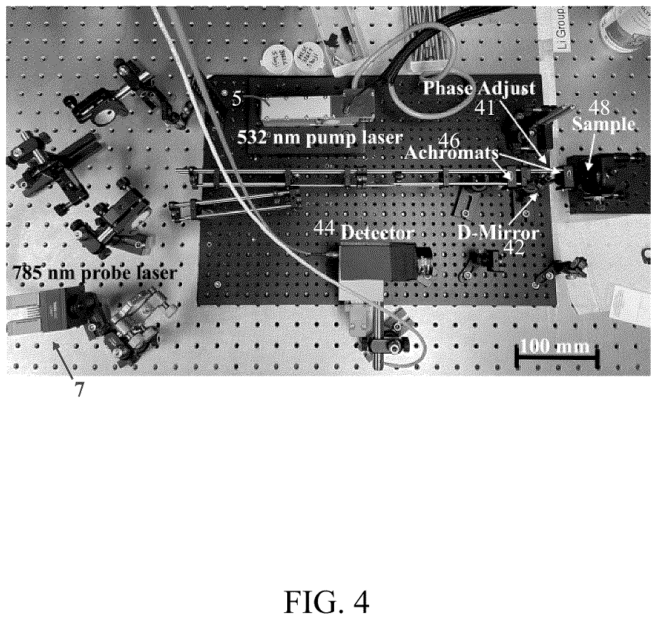

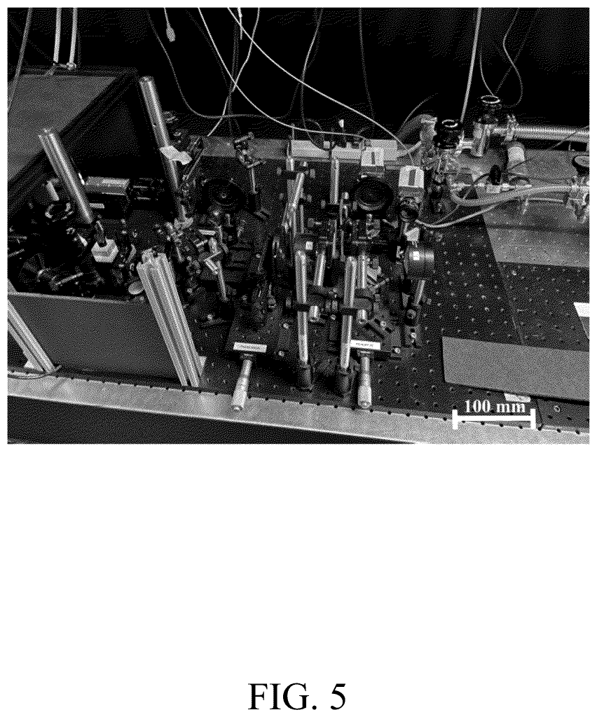

Example embodiments described herein also remove one of the probe beam systems. This means the system is a mono-homodyne system (The term heterodyne has historically been used. However, since the reference and signal beams are of the same frequency, homodyne is the correct term and is used herein) instead of a di-homodyne system. The advantage of a mono-homodyne system is that it requires significantly fewer optics and thus a more compact and simpler setup. However, a typical TGS system is di-homodyne to reduce noise and achieve a stable homodyne phase. The APP geometry could be modified to a di-homodyne setup to regain these benefits and keep much of the simplicity. The APP geometry does not have a chopper, which will affect sample heating and may become important in sensitive samples. However, any effects from sample heating were not observable in the present data. The comparison between FIGS. 4 and 5 shows how much simpler the setup presented herein is compared to the current state-of-the-art TGS systems.

The pump laser 5 and probe laser 7 and the phase mask 40 in this setup may be the same models with the same wavelengths as in common box-car setups^{7,14,19}. In some example embodiments, such as the one shown in FIG. 2, the incident pump beam 12 and the incident probe beam 14 are incident at the phase mask 40 at approximately the same location. The pump laser 5 may be a 532 nm pulsed laser from Teem Photonics with a 500 ps pulse duration, 1 kHz repetition rate, and 3 μJ per pulse. The probe laser 7 may be a 785 nm TO-Can diode laser with 300 mW of power and volume-holographic-grating to ensure a narrow linewidth. The grating spacing on the sample may be nominally 7.6 μm. The setup uses a fixed grating for simplicity, but the same geometry could be used with a variable grating system to probe different depths into a sample. The 0th-order diffracted beams of both the pump and the probe may be blocked after the phase mask. In alternative embodiments, the pump may have different characteristics. In alternative embodiments, the probe may have different characteristics. In alternative embodiments, the 0th-order diffracted beams of the pump or probe may not be blocked.

In some example embodiments a phase mask separates pump electromagnetic radiation into pump components. In alternative embodiments, alternative mechanisms are used, for example any mechanism suitable for producing two pump beams intersecting at a common point on a plane (e.g., two pump beams sent in to cross at a specific angle and then travel into the lenses).

In some example embodiments a phase mask separates probe electromagnetic radiation into a reference component and a probe component. In alternative embodiments, alternative mechanisms are used, for example any mechanism suitable for producing two beams intersecting at a common point on a plane (e.g., two pump beams sent in to cross at a specific angle and then travel into the lenses).

The homodyne phase of the diffracted and reflected beams is controlled by an adjustable OD=2.0 neutral density filter 41, serving as both detector protection and homodyne phase control. This allows for the removal of additional phase optics. In some example embodiments, the characteristics of the neutral density filter are different.

The APP arrangement of the setup also simplifies the beam pickoff. Once the beam has been picked off by a D-mirror 42, it is routed into an avalanche photodiode detector (for example, a Hamamatsu® C5658) with bandwidth limits of 1 GHz and 50 kHz with a −3 dB signal loss. A lens focuses the signal beam onto the detector which is housed in a light-tight enclosure. In some example embodiments, the characteristics of the optical collection path are different. In some example embodiments, the characteristics of the detector are different. In some example embodiments, a different type of mirror is used instead of a D-mirror.

In some example embodiments, the phase mask 40 may be configured to separate the incident pulsed pump electromagnetic radiation 12 along a pump incident path into a zeroth order pump component and non-zeroth order pump components.

In some example embodiments, the phase mask 40 may be configured to separate incident probe electromagnetic radiation 14 traveling along a probe incident path, angularly offset from the pump incident path, into a zeroth order probe component and non-zeroth order probe components, the non-zeroth order probe components including a reference component 30 and a probe component 20, the non-zeroth order pump components 10, the reference component 30, and the probe component 20 being substantially in a common plane.

In some example embodiments, the Mini-TGS system may comprise optical elements arranged to direct the non-zeroth order pump components 10 to an inspection location at the sample and to direct the reference component 30 and the probe component 20 to the inspection location, the non-zeroth order pump components 10 forming a sample transient grating 50 at the inspection location and the reference component 30 and at least a portion of the probe component 20 forming a homodyned signal in a detection path as a function of interaction with the sample transient grating 50, at least a portion of the homodyned signal 32 being substantially in the common plane. In some example embodiments, the homodyned signal 32 includes portions of the reference component 30 and/or a portion of the probe component 20 that are diffracted from the sample transient grating 50.

In some example embodiments, the optical components include one or more achromat lenses 46. In some example embodiments, the optical components include one or more alternative types of lenses.

In some example embodiments, the Mini-TGS system may comprise a detector 44 arranged to detect the homodyned signal 32 for use in collecting data for characterizing the sample 48. In some example embodiments, a reflected probe component 22 may not be used to characterize the sample.

The APP arrangement of the setup dictates is that the probe component 20 and the reference component 30 travel different lengths. In a traditional TGS setup, after the phase mask, the probe beams (reference component 30 and probe component 20) are symmetrical about the pump but not flat. This means each set of probe beams travels the same distance. In the planar setup, the outermost probe beam travels a slightly longer distance. For the planar nature of the setup to be viable, the difference in distance traveled must be less than the coherence length of the laser. The reference component 30 travels less than a millimeter further than the probe component 20 and the coherence length of the probe laser used in this setup is on the order of meters, so this ultimately is not an issue. Additionally, phase changes due to motion in the Z-direction from the asymmetric probe occur when changes are on the order of 10 μm. This is well beyond the surface roughness of any standard metallographic mirror preparation.

The APP geometry allows for the upstream design to be as simple as possible while still being able to be aligned. Both the incident pump beam 12 and the incident probe beam 14 go through two kinematically mounted, dual-axis mirrors to enable full alignment. After the mirrors, the beams may enter a fixed cage system that is fixed in the correct location on a breadboard and has two caged irises on it. The beams can then be aligned through the irises which can easily be done by eye. Once complete, the beams are within 500 μm of where they need to be. A beam imager or microscope eyepiece is used to do the final adjustment and make sure the probe hits the sample 48 at the same spot as the pump.

The asymmetric probe path lengths means the relative phase of the two probe beams (reference component 30 and probe component 20) changes as a function of the position of the sample 48 along the axis normal to the sample. This makes the phase plate important to align the system to the correct phase, but a phase plate is still necessary for a conventional setup. Thermal expansion may disrupt signal phase and the phase can be recovered using the phase plate. Given the demonstrative nature of this Mini-TGS, the setup could be miniaturized further while taking advantage of the APP geometry.

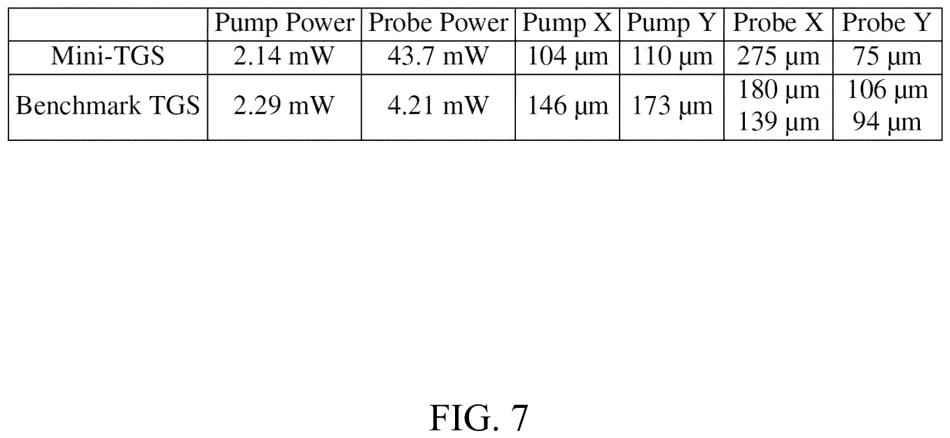

To ensure an example embodiment of the Mini-TGS system functions properly and produces correct results, signals were obtained from a 99.99% pure tungsten sample polished to a mirror finish with a {001} surface orientation and ±0.1 misorientation on both the Mini-TGS and a TGS system detailed by Dennett and Short which from hereon shall be referred to as the “benchmark” system²⁰. Tungsten is used to compare the two setups because the high degree of SAW speed isotropy of the sample enables convenient comparison²¹. In addition to testing with the same sample, the benchmark system uses the same pump, probe, and detector as the Mini-TGS. Two differences between the example setups are that the benchmark setup is a di-homodyne system whereas the Mini-TGS is single-homodyne and the benchmark setup uses an optical chopper to chop the probe with a frequency of 1 kHz while the Mini-TGS does not. Full schematics of both setups can be seen in FIGS. 2 and 3. The on-sample power and beam spot size, measured using the FWHM of the Gaussian fit, differ between the two setups. These numbers can be seen in FIG. 7. There are two probe sizes for the benchmark system because it is a di-homodyne system. In alternative embodiments, the Mini-TGS may use an optical chopper.

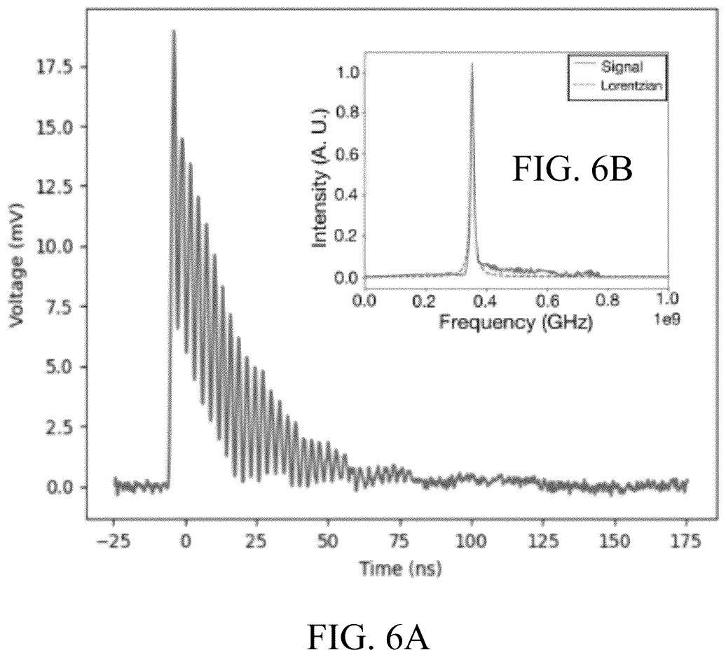

The data was taken on both setups without a vacuum-so the effect of TGS in air is present in the signal and can be seen in FIGS. 6A-6B. This means that the SAW frequency is the appropriate parameter to compare across the two setups because the air will affect the thermal diffusivity and acoustic damping. For each signal, 6,000 traces were averaged and then fit using the solution to the equation of thermoelasticity shown in Equation 1 using iterative parameter estimation and a nonlinear least-squares fit^{1,20}. Details about the origins of each term in Equation 1 equation can be found in Wylie et al.¹⁹.

$${I}_{tot} = A [ erfc ( q \sqrt{{α}_{x} t} ) + \frac{β}{\sqrt{t}} {e}^{- {q}^{2} {α}_{x} t} ] + B [ sin ( 2 π ft + Θ ) {e}^{\frac{- t}{τ}} ] + C \qquad ( 1 )$$

In this equation erfc is the complementary error function; αₓ is the surface-plane thermal diffusivity; ι, τ, and f are the phase, decay time, and frequency respectively, of the SAWs; β is the ratio of contributions from thermal (reflectivity) and displacement (amplitude) portions to the total diffraction signal; q is the grating wavenumber, equivalent to (2·π)/Λ and A, B, and C are fitting constants without physical significance to the signals presented herein. The signal was first fit to a naïve erfc(q\sqrt{αₓt}) curve to account for thermal decay. This signal was then subtracted from the original signal to isolate the SAW component of the signal which was then processed using the Fast Fourier Transform (FFT) to transform the signal to the frequency domain. The FFT was then fit to a Lorentzian curve to find the peak frequency. This peak is the SAW frequency, fin Equation 1 for this point on the sample.

When collecting data, a low-frequency electrical noise was present. This noise is constant enough that it can be subtracted away. For all data acquired on the Mini-TGS, a baseline signal was acquired by blocking the pump and keeping all else constant. This signal was subtracted from the raw signal. This electrical noise was not present on the benchmark setup.

The SAW frequency of the signal from an example embodiment of the Mini-TGS is similar to that of the benchmark setup. The average SAW frequency across 25 signals on the Mini-TGS was 353.7 MHz with a standard deviation of 1.2 MHz. The average SAW frequency across 25 signals on the benchmark setup was 354.8 MHz with a standard deviation of 0.4 MHz. These numbers demonstrate that the Mini-TGS system with the APP geometry can produce valid signals.

A common concern for TGS systems is variations in signal due to small changes in phase. 22 data points were acquired from the sample spot on the sample at different homodyne phases between −π/2 and π/2 and the SAW frequency was between 352 MHz and 354 MHz for all of the data points. This shows that the system does not need to be at precisely −π/2 or π/2 phase to be functional for measuring SAW frequency. For applications like measuring changes in SAW frequency due to radiation damage, this is a small enough difference as a function of phase⁷. However, there are some applications where precise SAW frequency may be necessary such as in directional slowness studies. In these cases, knowing the exact phase is necessary¹¹.

An example of a signal produced by the Mini-TGS after the baseline subtraction described above can be seen in FIG. 6A and an example of the FFT and resulting Lorentzian fit obtained by the procedure described above for a signal collected on the Mini-TGS is shown in the inset in FIG. 6B.

Example embodiments described herein drastically simplify the TGS system while maintaining the core functionality. The system turns TGS into an asymmetric optically 2D system by rotating the probe such that it is in the same plane as the pump. This reduces the number of necessary optics allowing a mono-homodyne system to function. This enables cage systems with fixed posts to be used to simplify alignment, lowering the barrier to entry for TGS thus allowing many more labs around the world to conduct research using this powerful technique. It also enables TGS to be used where size would have prevented a conventional TGS system from being used, such as in situ beam lines and on-site reactor pressure vessel analysis. A comparison of SAW frequency data from the same tungsten calibration sample on the Mini-TGS and a benchmark setup demonstrates that the Mini-TGS is producing valid TGS data.

### REFERENCES

[1] O. Kading, H. Skurk, A. Maznev, and E. Matthias, “Transient thermal gratings at surfaces for thermal characterization of bulk materials and thin films,” Appl. Phys. A 61, 253-261 (1995).
[2] J. Rogers and K. Nelson, “A new photoacoustic/photothermal device for real-time materials evaluation: An automated means for performing transient grating experiments,” Physica B: Condensed Matter 219-220, 562-564 (1996), pHONONS 95.
[3] J. A. Johnson, A. A. Maznev, M. T. Bulsara, E. A. Fitzgerald, T. C. Harman, S. Calawa, C. J. Vineis, G. Turner, and K. A. Nelson, “Phase-controlled, heterodyne laser-induced transient grating measurements of thermal transport properties in opaque material,” Journal of Applied Physics 111, 023503 (2012), https://pubs.aip.org/aip/jap/articlepdf/doi/10.1063/1.3675467/13978676/023503_1_online.pdf.
[4] N. Gedik, J. Orenstein, R. Liang, D. A. Bonn, and W. N. Hardy, “Diffusion of nonequilibrium quasi-particles in a cuprate superconductor,” Science 300, 1410-1412 (2003), https://www.science.org/doi/pdf/10.1126/science.1083038.
[5] L. Yang, J. D. Koralek, J. Orenstein, D. R. Tibbetts, J. L. Reno, and M. P. Lilly, “Measurement of electron-hole friction in an n-doped GaAs/AlGaAs quantum well using optical transient grating spectroscopy,” Phys. Rev. Lett. 106, 247401 (2011).
[6] J. Janušonis, T. Jansma, and C. L. Chang et al., “Transient grating spectroscopy in magnetic thin films: Simultaneous detection of elastic and magnetic dynamics,” Sci Rep 6, 29143 (2016).
[7] C. Dennett, A. Kushima, K. So, K. Hattar, and M. Short, “Irradiation-induced void swelling in pure copper characterized using transient grating spectroscopy,” Transactions of the American Nuclear Society 117, 201-204 (2017).
[8] N. Boechler, J. K. Eliason, A. Kumar, A. A. Maznev, K. A. Nelson, and N. Fang, “Interaction of a contact resonance of microspheres with surface acoustic waves,” Phys. Rev. Lett. 111, 036103 (2013).
[9] S. Robertson, Evaluating Fluoride Molten Salt Thermophysical Properties with Transient Grating Spectroscopy, Ph.D. thesis, Massachusetts Institute of Technology (2022).
[10] S. E. Ferry, C. A. Dennett, K. B. Woller, and M. P. Short, “Inferring radiation-induced microstructural evolution in single-crystal niobium through changes in thermal transport,” Journal of Nuclear Materials 523, 378-382 (2019).
[11] P. Stoklasová, T. Grabec, K. Zoubková, P. Sedlák, S. Krátky, and H. Seiner, “Laser-ultrasonic characterization of strongly anisotropic materials by transient grating spectroscopy,” Experimental Mechanics 61, 663-676 (2021).
[12] C. Dennett, R. Choens, and C. A. Taylor et al., “Listening to radiation damage in situ: Passive and active acoustic techniques,” JOM 72, 297-209 (2020).
[13] G. Zhang, Bulk and Surface Acoustic Waves Fundamentals, Devices, and Applications (Jenny Stanford Publishing, Singapore, 2022).
[14] A. Wylie, A. Reza, G. Harrison, M. Taylor, B. Dacus, F. Hofmann, M. Short, S. Kirk, M. Preuss, and E. Pickering, “Thermal diffusivity, microstructure and nanohardness of laser-welded proton-irradiated eurofer97,” Journal of Nuclear Materials 586, 154661 (2023).
[15] N. Almousa, B. Dacus, K. B. Woller, J. H. Shin, C. Jang, L. Shao, F. A. Garner, A. Gabriel, and M. P. Short, “On the use of non-destructive, gigahertz ultrasonics to rapidly screen irradiated steels for swelling resistance,” Materials Characterization 174, 111017 (2021).
[16] F. Hofmann, M. Short, and C. Dennett, “Transient grating spectroscopy: An ultrarapid, nondestructive materials evaluation technique,” MRS Bulletin 44, 392-402 (2019), https://doi.org/10.1557/mrs.2019.104.
[17] M. Gostein, A. A. Maznev, P. Krastev, and A. Mazurenko, “Applications of laser-generated surface acoustic waves for copper film process monitoring in integrated circuit industry (abstract),” Review of Scientific Instruments 74, 739-739 (2003), https://pubs.aip.org/aip/rsi/articlepdf/74/1/739/19279396/739_1_online.pdf.
[18] B. Verstraeten, J. Sermeus, R. Salenbien, J. Fivez, G. Shkerdin, and C. Glorieux. “Determination of thermoelastic material properties by differential heterodyne detection of impulsive stimulated thermal scattering,” Photoacoustics 3, 64-77 (2015).
[19] A. P. C. Wylie, K. B. Woller, S. A. A. Al Dajani, B. R. Dacus, E. J. Pickering, M. Preuss, and M. P. Short, “Thermal diffusivity in ion-irradiated single-crystal iron, chromium, vanadium, and tungsten measured using transient grating spectroscopy,” Journal of Applied Physics 132, 045102 (2022), https://pubs.aip.org/aip/jap/articlepdf/doi/10.1063/5.0089048/16511663/045102_1_online.pdf.
[20] C. A. Dennett and M. P. Short, “Thermal diffusivity determination using heterodyne phase insensitive transient grating spectroscopy,” Journal of Applied Physics 123, 215109 (2018), https://pubs.aip.org/aip/jap/articlepdf/doi/10.1063/1.5026429/15213309/215109_1_online.pdf.
[21] C. A. Dennett, P. Cao, S. E. Ferry, A. Vega-Flick, A. A. Maznev, K. A. Nelson, A. G. Every, and M. P. Short, “Bridging the gap to mesoscale radiation materials science with transient grating spectroscopy,” Phys. Rev. B 94, 214106 (2016).

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A transient grating spectroscopy system for characterizing a sample, comprising:
a means for:
separating pulsed pump electromagnetic radiation propagating along a pump incident path into pump components; and
separating probe electromagnetic radiation propagating along a probe incident path, angularly offset from the pump incident path, into a reference component and a probe component, the reference component, and the probe component being substantially in a common plane;
optical elements arranged to direct the pump components to an inspection location on an inspection surface at the sample and to direct the reference component and the probe component to the inspection location, the pump components forming a sample transient grating at the inspection location and the reference component and at least a portion of the probe component forming a homodyned signal in a detection path as a function of interaction with the sample transient grating, the optical elements arranged to direct the reference component and the probe component to the inspection location from a forward path side of a plane that intersects the inspection surface, the detection path being at a reverse path side of the plane, at least a portion of the homodyned signal being substantially in the common plane; and
a detector arranged to detect the homodyned signal for use in collecting data for characterizing the sample.

2. The system of claim 1, wherein the means for separating the pulsed pump electromagnetic radiation and separating the probe electromagnetic radiation includes a phase mask.

3. The system of claim 1, further comprising a pump source configured to emit the pulsed pump electromagnetic radiation along the pump incident path and a probe source configured to the emit probe electromagnetic radiation along the probe incident path.

4. The system of claim 3, further comprising a fixture, optical elements, or combination thereof, constructed and arranged to secure the pump source and the probe source such that the pump incident path and the probe incident path are at the angular offset.

5. The system of claim 1, wherein the wavelength of the probe electromagnetic radiation is different than the wavelength of the pump electromagnetic radiation.

6. The system of claim 2, wherein the reference component propagates from the phase mask to the inspection location along a reference component path and the probe component propagates from the phase mask to the inspection location along a probe component path, the length difference between the reference component path and the probe component path being less than the coherence length of the probe source.

7. The system of claim 2, wherein the pump incident path is configured to be orthogonally incident at a position of the phase mask and the probe incident path is configured to be non-orthogonally incident at the position of the phase mask.

8. The system of claim 1, wherein the optical elements include a pump beam stop configured to block the zeroth order pump component, and a probe beam stop configured to block the zeroth order component of the probe electromagnetic radiation.

9. The system of claim 1, wherein the reference component is a (+1) order probe component of the probe electromagnetic radiation, and the probe component is a (−1) order probe component of the probe electromagnetic radiation.

10. The system of claim 1, wherein the homodyned signal comprises the reflection of the reference component and the diffraction of the probe component off the sample transient grating.

11. The system of claim 1, wherein the detector is communicatively coupled with a signal processor that is configured to interpret a representation of the homodyned signal produced by the detector to be the characteristic of the sample.

12. The system of claim 2, wherein the phase mask, optical elements, and detector are elements in a handheld device.

13. The system of claim 2, wherein the pump components include a positive order pump component and a corresponding equivalent negative order pump component, the phase mask and optical components being configured to direct the positive order pump component and the corresponding negative order pump component to the inspection location such that the two pump components are symmetric about the plane that intersects with the inspection surface.

14. A method of using transient grating spectroscopy, comprising:
separating a pulsed pump electromagnetic radiation along a pump incident path into pump components;
separating probe electromagnetic radiation traveling along a probe incident path, angularly offset from the pump incident path, into a reference component and a probe component, the reference component, and the probe component being substantially in a common plane;
directing the pump components to an inspection location on an inspection surface at a sample;
directing the reference component and the probe component to the inspection location at the sample from a forward path side of a plane that intersects the inspection surface, the pump components forming a sample transient grating at the inspection location and the reference component and at least portion of the probe component forming a homodyned signal in a detection path as a function of interaction with the sample transient grating, the detection path being at a reverse path side of the plane, at least a portion of the homodyned signal being substantially in the common plane; and
detecting the homodyned signal for use in collecting data for characterizing the sample.

15. A method of using transient grating spectroscopy, comprising:
illuminating an inspection location on an inspection surface with pump electromagnetic radiation along a first pump incident path and a second pump incident path to form a sample transient grating at the inspection location, the first pump incident path and the second pump incident path being symmetric about a plane that intersects with the inspection location;
illuminating the inspection location with reference electromagnetic radiation along a reference incident path and with probe electromagnetic radiation along a probe incident path, the reference incident path and the probe incident path being incident from a forward path side of the plane that intersects with the inspection surface; and
detecting collected electromagnetic radiation that propagates along a collection path, the collected electromagnetic radiation resulting from interactions of the reference electromagnetic radiation, the probe electromagnetic radiation, and the sample transient grating, the collection path being at a reverse path side of the plane that intersects with the inspection surface.

16. The method of claim 15, wherein the first pump incident path, the second pump incident path, the reference incident path, the probe incident path, and the collection path are in a common plane.

17. The method of claim 16, wherein the common plane is substantially horizontal relative to a surface to which optical components used to perform the method are mounted.

18. The method of claim 15, further comprising:
separating the pump electromagnetic radiation, using a phase mask, into the first pump incident path and the second pump incident path; and
separating the incident probe electromagnetic radiation, using a phase mask, into the reference electromagnetic radiation along the reference incident path and the probe electromagnetic radiation along the probe incident path.

19. The method of claim 15, wherein the homodyned signal comprises the reflection of the reference component of the probe electromagnetic radiation and the diffraction of the probe component of the probe electromagnetic radiation off the sample transient grating.

20. The method of claim 15, wherein the plane intersects with the inspection surface at an orthogonal angle.
